(19) United States
(12) Patent Application Publication
(10) Pub. No.: US 2016/0200587 A1
(43) Pub. Date: Jul. 14, 2016

(54) METHOD FOR MANUFACTURING HYDRATED MAGNESIUM CARBONATE

(71) Applicant: INDUSTRY FOUNDATION OF CHONNAM NATIONAL UNIVERSITY, Gwangju (KR)

(72) Inventors: Myong Jun KIM, Gwangju (KR); Tam TRAN, Gwangju (AU)

(21) Appl. No.: 14/818,264

(22) Filed: Aug. 4, 2015

(30) Foreign Application Priority Data
Jan. 8, 2015 (KR) 10-2015-0002905

(51) Int. Cl. C01F 5/24

(52) U.S. Cl. CPC C01F 5/24

(57) ABSTRACT

Disclosed is a method for manufacturing hydrated magnesium carbonate. Designed to produce high-purity hydrated magnesium carbonate from a solution where calcium ions and magnesium ions coexist, the method can add value to the resources. Compared to conventional techniques, the method can be conducted in a simpler procedure and allows for the production of high purity magnesium oxide (MgO), thus bringing about an economical benefit.

### BACKGROUND

1. Field of the Invention

The present invention relates to a method for manufacturing hydrated magnesium carbonate. More particularly, the present invention relates to a method for manufacturing hydrated magnesium carbonate (HMC) and magnesium oxide (MgO) in a solution where calcium ions and magnesium ions coexist.

2. Description of the Related Art

Magnesium and its compounds have found applications in various fields including insulation and construction, agricultural, chemical, and other industries. With the increasing demand for magnesium alloys in the automobile industry, the world production of magnesium has exceeded 429,000 tpa, and has been increasing yearly. Magnesium is found in large deposits of dolomite, magnesite, brucite, serpentine, etc. For practical use, these magnesium-containing ores are processed into refractory materials, or agriculturally useful materials.

High-purity magnesium products may be processed from seawater, bittern, and saline water. The content of magnesium in seawater approximates to 1˜1.3 g/L, with seawater and bittern estimated to contain hundreds million tons of materials for magnesium bearings. Magnesium oxide (MgO) of high purity is used particularly in foods and medicines, and Mg(OH)₂ and hydrated magnesium carbonate are considered among excellent fire retardants.

Mg ores such as magnesite are calcined or melted for a long period of time to produce magnesia or magnesium oxide, which are used predominantly as refractory agents, while Mg chloride or hydroxide, used as an additive for fire retardants, medicaments, foods, etc., is produced, for the most part, from seawater and bittern.

Production of magnesium oxide from dolomite or magnesite may be achieved by calcining dolomite or magnesite. Then, the calcine is converted into magnesium chloride, using seawater and hydrogen chloride, followed by removing water of crystallization. However, this method is economically inefficient in that selective separation is not made of unreacted calcium oxide during the production of magnesium chloride and the removal of water of crystallization is further needed.

Hence, there is a demand for research into the production of high purity hydrated magnesium carbonate, together with highly pure magnesium oxide, using a simple method whereby high added-value products can be created.

### SUMMARY

Leading to the present invention, intensive and thorough research into the production of hydrated magnesium carbonate (HMC) resulted in the finding that a solution where calcium and magnesium ions coexist can be used for the production of hydrated magnesium carbonate (HMC).

It is therefore an object of the present invention to provide a manufacturing method of hydrated magnesium carbonate whereby highly pure hydrated magnesium carbonate (HMC) can be produced from a solution where calcium and magnesium ions coexist, thus creating a high added value product.

It is another object of the present invention to provide a manufacturing method of high purity hydrated magnesium carbonate, which can be conducted in a simpler procedure compared to conventional techniques and which allows for the production of magnesium oxide (MgO) of high purity, thus bringing about an economical benefit.

The present invention will now be further described. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

To accomplish the above objects, one aspect of the present invention provides a method for manufacturing hydrated magnesium carbonate, comprising: preparing a material solution containing calcium and magnesium, and a carbonate solution; mixing the material solution with the carbonate solution calcium while stirring to produce a first mixed solution, with the concomitant precipitation of magnesium carbonate; and mixing a hydroxide solution to the first mixed solution while stirring to produce a second mixed solution, with the concomitant precipitation of hydrated magnesium carbonate (HMC).

In one preferred embodiment of the present invention, the carbonate solution is used in such an amount that the magnesium of the material solution is mixed at a molar ratio of 1:0.6˜1:1.0 with carbonate ions.

In another preferred embodiment of the present invention, the carbonate solution is a sodium carbonate (Na₂CO₃) solution. Meanwhile, when sodium carbonate (Na₂CO₃) is added in such an amount that the magnesium of the material solution is at a molar ratio of 1:1.0 with carbonate ions, all the magnesium ions exist as MgCO₃.

In another preferred embodiment of the present invention, the hydroxide solution is used in such an amount that the magnesium of the material solution is mixed at a molar ratio of 1:0.1˜1:0.3 with hydroxide ions.

In another preferred embodiment of the present invention, the hydroxide solution is a sodium hydroxide (NaOH) solution. In another preferred embodiment of the present invention, the second mixed solution is maintained to have a pH of 8 to 10.

In another preferred embodiment of the present invention, the method may further comprise: filtering the second mixed solution to separate the precipitate; washing the precipitate to remove impurities from the precipitate; and drying the purified precipitate in an oven.

In another preferred embodiment of the present invention, the hydrated magnesium carbonate (HMC) is selected from the group consisting of 4(MgCO₃).Mg(OH)₂.4H₂O, 4(MgCO₃).Mg(OH)₂.5H₂O, and 4(MgCO₃).Mg(OH)₂.8H₂O.

In another preferred embodiment of the present invention, the method may further comprise roasting the dried precipitate at 800 to 1,000° C. to afford highly pure magnesium oxide (MgO).

According to another aspect thereof, the present invention provides a method for manufacturing hydrated magnesium carbonate, comprising: preparing a material solution containing calcium and magnesium, and a carbonate solution; mixing the material solution with the carbonate solution calcium while stirring to precipitate calcium carbonate; isolating the precipitated calcium carbonate; mixing the remaining solution with a carbonate solution by stirring to produce a first mixed solution, with the concomitant precipitation of magnesium carbonate; and adding a hydroxide solution to the first mixed solution while stirring to produce a second mixed solution, with the concomitant precipitation of hydrated magnesium carbonate (HMC).

In one preferred embodiment of the present invention, the carbonate solution is used in such an amount that the magnesium of the material solution is mixed at a molar ratio of 1:0.6˜1:1.0 with carbonate ions.

In another preferred embodiment of the present invention, the carbonate solution is a sodium carbonate (Na₂CO₃) solution.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flow diagram illustrating the production of high-purity hydrated magnesium carbonate (HMC) and magnesium oxide (MgO) from a solution containing both calcium and magnesium in accordance with an exemplary embodiment of the present invention.

FIG. 2 shows XRD spectra of various hydrated magnesium carbonates obtained by washing coarse hydrated magnesium carbonate;

FIG. 3 shows tables in which elemental compositions of high-purity hydrated magnesium carbonates dried at different temperatures are summarized;

FIG. 4 is an XRD spectrum of a product obtained by roasting the dried hydrated magnesium carbonate at 1000° C.;

FIG. 5 is a table in which an elemental composition of the high-purity magnesium oxide obtained is summarized; and

FIG. 6 is a flow diagram illustrating the production of high-purity hydrated magnesium carbonate (HMC) and magnesium oxide (MgO) from a solution containing both calcium and magnesium in accordance with another exemplary embodiment of the present invention.

### DETAILED DESCRIPTION

Before the present invention is described in detail below, it is to be understood that this invention is not limited to the particular methodology, protocols and reagents described herein as these may vary. It is also to be understood that the terminology used herein is for the purpose of describing particular embodiments only, and is not intended to limit the scope of the present invention, which will be limited only by the appended claims. Unless defined otherwise, all technical and scientific terms used herein have the same meanings as commonly understood by one of ordinary skill in the art.

Reference now should be made to the drawings, throughout which the same reference numerals are used to designate the same or similar components. Below, a description will be given of preferred embodiments of the present invention in conjunction with the accompanying drawings. Throughout the accompanying drawings, the same reference numerals are used to designate the same or similar components. It should be apparent to those skilled in the art that although many specified elements such as concrete components are elucidated in the following description, they are intended to aid the general understanding of the invention and the present invention can be implemented without the specified elements. Further, in the description of the present invention, when it is determined that the detailed description of the related art would obscure the gist of the present invention, description thereof will be omitted.

The present invention is technically characterized by production of high purity hydrated magnesium carbonate (HMC) from a solution where calcium ions and magnesium ions coexist.

In accordance with an aspect thereof, the present invention addresses a method for manufacturing magnesium carbonate, comprising preparing a material solution containing calcium and magnesium, and a carbonate solution; mixing the material solution with the carbonate solution calcium while stirring to give a first mixed solution with the concomitant precipitation of magnesium carbonate; and mixing a hydroxide solution to the first mixed solution while stirring to give a second mixed solution with the concomitant precipitation of hydrated magnesium carbonate (HMC).

Here, the material solution containing calcium and magnesium may be a solution where calcium ions and magnesium ions coexist, such as seawater, a leachate after the calcinations of dolomite or magnesite, or concentrated seawater after desalination. Given seawater, the solution has a pH of 6˜7.

The material solution containing calcium and magnesium, used in the present invention, is a solution from Daempier salt Ltd, Australia, in which Na (36.2 g/kg), Mg (41.1 g/kg), Ca (0.1 g/kg), K (11.4 g/kg), SO4²⁻ (64.0 g/kg), and B (0.2 g/kg) are contained. As seen, this solution is about 400-fold richer in magnesium (Mg) than calcium (Ca). In this regard, high purity hydrated magnesium carbonate can be obtained without a calcium removal process thanks to the scarce calcium.

The carbonate solution may be prepared using a source of carbonate ions (CO₃²⁻), such as sodium carbonate (Na₂CO₃). The carbonate solution is used in such an amount that the magnesium of the material solution is mixed at a molar ratio of 1:0.6˜1:1.0 with carbonate ions, and preferably at a molar ratio of 1:0.8.

The material solution and the carbonate solution are mixed together and stirred to give a first mixed solution. As soon as the material solution and the carbonate solution are mixed, magnesium carbonate forms as a precipitate. The resulting solution has a pH of 8.6˜8.8.

After a predetermined period of time, a hydroxide solution is mixed with the first mixed solution by stirring to give a second mixed solution. When the first mixed solution and the hydroxide solution are mixed together, hydrated magnesium carbonate (HMC) forms as a precipitate.

In this regard, the hydroxide solution is adjusted so as to keep the pH of the second mixed solution at or below 10, and preferably in a range of 8˜10. A pH exceeding 10 causes magnesium carbonate (MgCO₃) and magnesium hydroxide (Mg(OH)₂) rather than hydrated magnesium carbonate to form as precipitates.

The hydroxide solution is prepared using a source of hydroxide ions, for example, sodium hydroxide (NaOH). The hydroxide solution is used in such an amount that the magnesium of the material solution is mixed at a molar ratio of 1:0.1˜1:0.3 with hydroxide ions, and preferably at a molar ratio of 1:0.2.

Subsequently, the hydrated magnesium carbonate (HMC) precipitated in the second mixed solution is separated through a filter, washed to remove impurities therefrom, and dried in an oven to produce highly pure hydrated magnesium carbonate (HMC).

The high purity hydrated magnesium carbonate (HMC) thus obtained may be a light hydrated magnesium carbonate composed of 4(MgCO₃)Mg(OH)₂4H₂O or a heavy hydrated magnesium carbonate composed of 4(MgCO₃)Mg(OH)₂5H₂O and 4(MgCO₃)Mg(OH)₂8H₂O, depending on the temperature of the drying process.

Finally, the high purity hydrated magnesium carbonate (HMC) is roasted at as high as 800 to 1000° C. to afford high purity magnesium oxide (MgO).

In the above embodiment, a solution containing a concentration of magnesium (Mg) 400 times that of calcium (Ca) is used for the production of highly pure hydrated magnesium carbonate (HMC). In another exemplary embodiment of the present invention, highly pure hydrated magnesium carbonate (HMC) is produced from a solution containing Na (84.09 g/kg), Mg (9.59 g/kg), Ca (0.24 g/kg), and K (2.91 g/kg). That is, a solution in which the concentration of magnesium (Mg) is about 40 times that of calcium (Ca) is used. In this case, calcium removal is needed for the production of highly pure hydrated magnesium carbonate because calcium may act as an impurity to the hydrated magnesium carbonate.

In accordance with another aspect thereof, the present invention addresses a method for manufacturing hydrated magnesium carbonate, comprising: preparing a material solution containing calcium and magnesium, and a carbonate solution; mixing the material solution with the carbonate solution calcium while stirring to precipitate calcium carbonate; isolating the precipitated calcium carbonate; mixing the remaining solution with a carbonate solution by stirring to give a first mixed solution, with the concomitant precipitation of magnesium carbonate; and adding a hydroxide solution to the first mixed solution while stirring to give a second mixed solution, with the concomitant precipitation of hydrated magnesium carbonate (HMC).

First, a material solution containing calcium and magnesium, and a carbonate solution are prepared as in the above embodiment. Prior to the production of the first mixed solution, a calcium removal process is performed. That is, the material solution and the carbonate are mixed together and stirred to precipitate calcium carbonate, followed by separating the precipitated calcium carbonate.

When the material solution containing calcium and magnesium is mixed with the carbonate solution, precipitation occurs. In this regard, calcium carbonate and magnesium carbonate form concurrently as precipitates. In one embodiment of the present invention, the calcium precipitate, although acting as an impurity, is negligible because the concentration of calcium is about one four hundredth of that of magnesium. However, in the another embodiment, the calcium precipitate may play a significant role as an impurity in manufacturing hydrated magnesium carbonate because the amount of calcium amounts to one fortieth of that of magnesium. Thus, a calcium removal process is preferably conducted in advance.

The carbonate solution may be prepared using a source of carbonate ions (CO₃²⁻), such as sodium carbonate (Na₂CO₃). The carbonate solution is used in such an amount that the magnesium of the material solution is mixed at a molar ratio of 1:0.6˜1:1.0 with carbonate ions, and preferably at a molar ratio of 1:0.8. When sodium carbonate (Na₂CO₃) is added in such an amount that the magnesium of the material solution is at a molar ratio of 1:1.0 with carbonate ions, all the magnesium ions exist as MgCO₃.

Mixing the material solution with the carbonate solution by stirring precipitates calcium carbonate, which is then separated by solid-liquid separation. Magnesium carbonate precipitates simultaneously with calcium carbonate. The solid-liquid separation separates magnesium carbonate, too, causing magnesium to be lost. In spite of this loss, it is preferable to conduct the calcium removal process not only because the amount of lost magnesium is very small compared to that of the remainder, but also the solid-liquid separation can remove most of the calcium that may act as an impurity to hydrated magnesium carbonate. This was confirmed by the composition change of the material solution to Na (82.25 g/kg), Mg (8.62 g/kg), Ca (0.09 g/kg), and K (2.62 g/kg) after the calcium removal process.

Subsequent processes including mixing the first mixed solution with a hydroxide solution by stirring to give a second mixed solution, with the concomitant precipitation of hydrated magnesium carbonate (HMC), filtering, washing, drying, and roasting to afford highly pure magnesium oxide are the same as in the above embodiment.

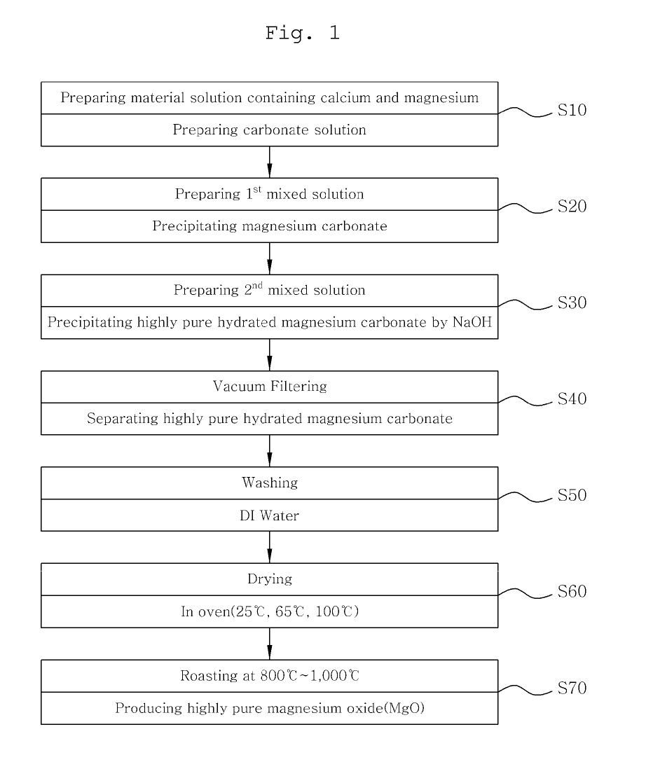

FIG. 1 is a flow chart illustrating the manufacture of high purity hydrated magnesium carbonate (HMC) and magnesium oxide (MgO), with a calcium and magnesium solution serving as a starting material, in accordance with one embodiment of the present invention.

In conjunction with FIG. 1, a method for manufacturing high purity hydrated magnesium carbonate (HMC) and magnesium oxide (MgO) in accordance with one embodiment of the present invention will be explained, below.

A better understanding of the present invention may be obtained through the following examples which are set forth to illustrate, but are not to be construed as the limit of the present invention.

### EXAMPLE 1

Manufacturing Method of High Purity Hydrated Magnesium Carbonate (HMC) and Magnesium Oxide (MgO)

(S10) Preparation of Material Solution and Carbonate Solution

A material solution in which calcium ions and magnesium ions coexisted, and a carbonate solution were prepared. In this Example, the carbonate solution was prepared of sodium carbonate (Na₂CO₃). The material solution was a Daempier Salt Ltd solution in which Na (36.2 g/kg), Mg (41.1 g/kg), Ca (0.1 g/kg), K (11.4 g/kg), SO4²⁻ (64.0 g/kg), and B (0.2 g/kg) were contained. That is, the material solution was about 400-fold richer in magnesium (Mg) than calcium (Ca).

The material solution used in this experiment amounted to 5 kg, with a pH of 6.95.

The carbonate solution was made to have a concentration of 1.932 M by dissolving 716.8 g of a solid-phase sodium carbonate (Na₂CO₃) in 3.5 L of seawater, so that a molar ratio of 1:0.8 was set between the magnesium ions of the material solution and the carbonate ions (CO₃²⁻) of the carbonate solution.

(S20) Preparation of First Mixed Solution

The carbonate solution was added to the material solution where calcium and magnesium ions coexisted to precipitate magnesium carbonate. The resulting mixture in which magnesium and carbonate ions (CO₃²⁻) were present at a molar ratio of 1:0.8 was stirred for 2 hrs to precipitate magnesium carbonate, as shown in Reaction Scheme 1. In this regard, the first mixed solution was maintained at a pH of 8.6 to 8.8.

4Mg²⁺+4Na₂CO₃+12H₂O→4(MgCO₃.3H₂O)+8Na⁺ [Reaction Scheme 1]

(S30) Preparation of Second Mixed Solution (Precipitation of High Purity Hydrated Carbonate)

After the preparation of the first mixed solution (S20), a hydroxide solution was added to the first mixed solution to give a second mixed solution, with the concomitant precipitation of hydrated magnesium carbonate. In this Example, the hydroxide solution was made of sodium hydroxide (NaOH). In this regard, 135.25 g of solid-phase NaOH was dissolved in 1.4 L of seawater to prepare a 2.415 M hydroxide that was suitable for setting a molar ratio of 1:0.2 between the magnesium of the material solution and the hydroxide ions (OH⁻).

When the first mixed solution was stirred together with a hydroxide solution for 4 hrs, hydrated magnesium carbonate precipitated as illustrated by Reaction Scheme 2. The resulting second mixed solution was maintained at a pH of 10 or less.

4(MgCO₃.3H₂O)+Mg²⁺+2NaOH→4(MgCO₃).Mg(OH)₂.8H₂O)+2Na⁺+4H₂O [Reaction Scheme 2]

(S40) Filtration

The second mixed solution in which hydrated magnesium carbonate was present as a precipitate was filtered in a vacuum using a vacuum pump.

(S50) Washing

After filtration, the hydrated magnesium carbonate thus obtained was washed many times (three or more times) with DI water to remove impurities (Na, Cl, SO₄²⁻, etc.) therefrom.

(S60) Drying

After washing, the coarse hydrated magnesium carbonate was dried to produce light hydrated magnesium carbonate or heavy hydrated magnesium carbonate depending on a drying condition.

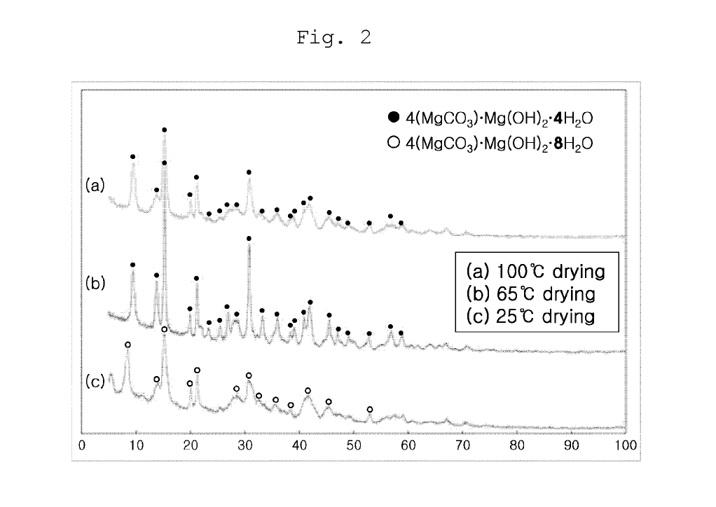

With reference to FIG. 2, the coarse hydrated magnesium carbonate was dried at 100° C. and 65° C. to provide light hydrated magnesium carbonate 4(MgCO₃).Mg(OH)₂.4H₂O, and at 25° C. to produce heavy hydrated magnesium carbonate 4(MgCO₃).Mg(OH)₂.8H₂O).

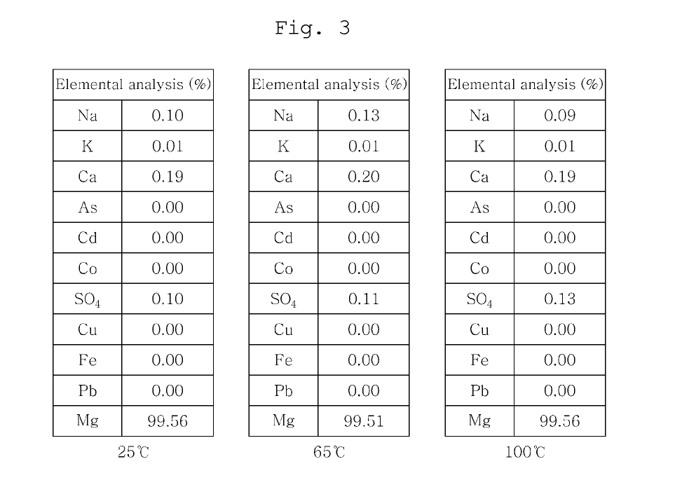

Turning to FIG. 3, compositions of the highly pure hydrated magnesium carbonates obtained at respective drying temperatures are shown. The heavy hydrated magnesium carbonate 4(MgCO₃).Mg(OH)₂.8H₂O) dried at 25° C. contained 99.56% of magnesium (Mg) while the content of magnesium (Mg) was 99.51% in the light hydrated magnesium carbonate 4(MgCO₃).Mg(OH)₂.4H₂O) dried at 65° C., and 99.56% in the light hydrated magnesium carbonate 4(MgCO₃).Mg(OH)₂.4H₂O) dried at 100° C.

(S70) Roasting

The hydrated magnesium carbonate was roasted at 800° C. or higher (approximately 1,000° C.) for 3 hrs to finally leave magnesium oxide (MgO) as H₂O, and CO₂ was removed therefrom. This reaction is as shown in Reaction Scheme 3.

4(MgCO₃).Mg(OH)₂.nH₂O)→MgO+CO₂↑+H₂O↑ [Reaction Scheme 3]

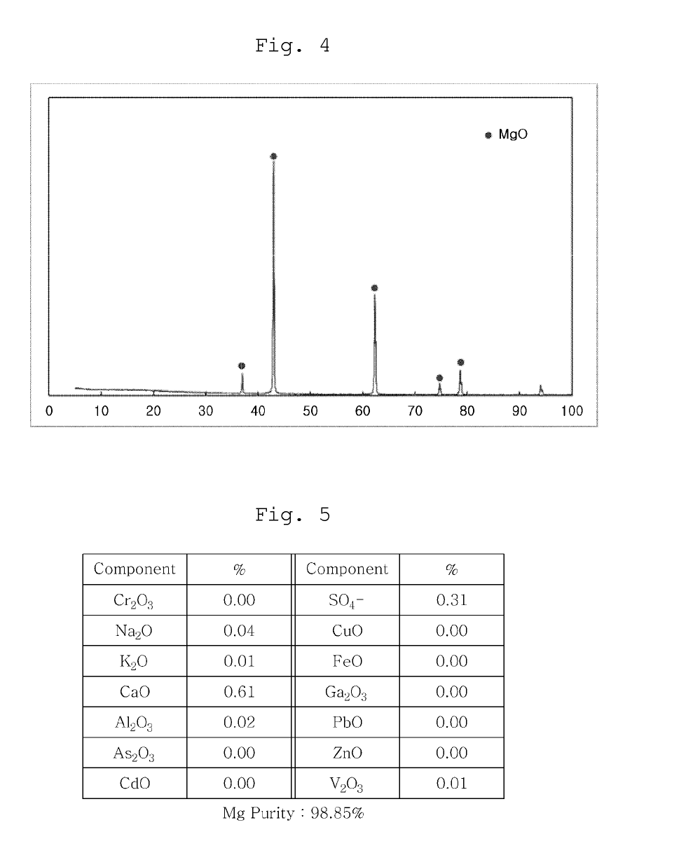

FIG. 4 is an XRD spectrum of the product after the hydrated magnesium carbonated was roasted at 1000° C. As is understood from the XRD spectral data, the product was MgO. Referring to FIG. 5, the magnesium was very pure with a purity of 98.85%.

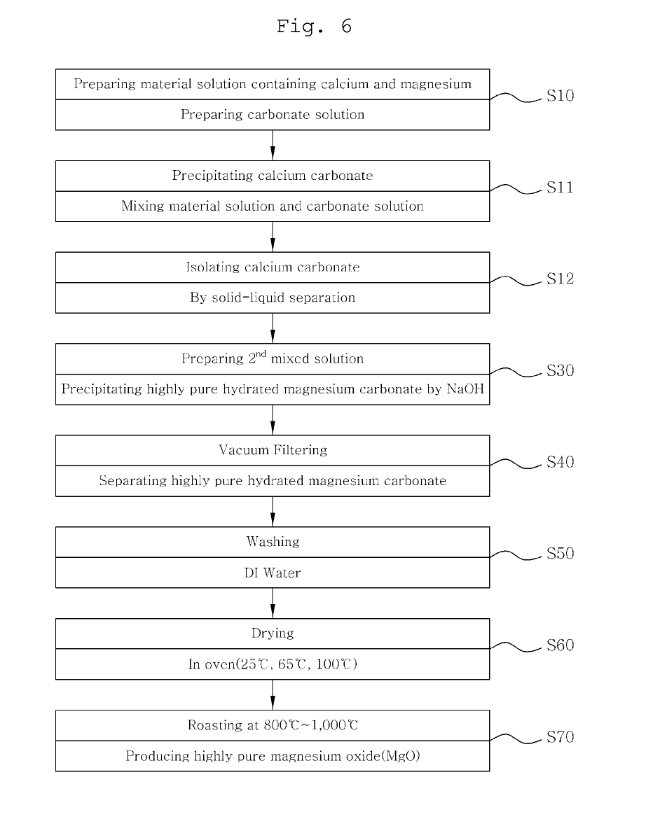

FIG. 6 is a flow chart illustrating the manufacture of high purity hydrated magnesium carbonate (HMC) and magnesium oxide (MgO), with a calcium and magnesium solution serving as a starting material, in accordance with another embodiment of the present invention.

In conjunction with FIG. 1, a method for manufacturing highly pure hydrated magnesium carbonate (HMC) and magnesium oxide (MgO) in accordance with another embodiment of the present invention will be explained, below.

### EXAMPLE 2

Manufacturing Method of High Purity Hydrated Magnesium Carbonate (HMC) and Magnesium Oxide (MgO)

(S10) Preparation of Material Solution and Carbonate Solution

A material solution in which calcium ions and magnesium ions coexisted, and a carbonate solution were prepared. In this Example, the carbonate solution was prepared of sodium carbonate (Na₂CO₃). The material solution was a diluted salt liquor/brine from Daempier Salt Ltd in which Na (84.09 g/kg), Mg (9.59 g/kg), Ca (0.24 g/kg), and K (2.91 g/kg) were contained. That is, the material solution was about 40-fold richer in magnesium (Mg) than calcium (Ca).

The amount of the material solution used in this experiment was 500 mL, with a magnesium content of 9.6 g/kg. The carbonate solution was made to have a concentration of 1.932 M by dissolving 3.48 g of a solid-phase sodium carbonate (Na₂CO₃), so that a molar ratio of 1:0.8 was set between the magnesium ions of the material solution and the carbonate ions (CO₃²⁻) of the carbonate solution.

(S11) Precipitation of Calcium Carbonate

The carbonate solution was added to the material solution where calcium and magnesium ions coexisted to precipitate calcium carbonate. This step was to remove the calcium (Ca) that might act as an impurity to the final product HMC. The resulting mixture in which magnesium and carbonate ions (CO₃²⁻) were present at a molar ratio of 1:0.8 was stirred for 1 hr to precipitate calcium carbonate, as shown in Reaction Scheme 4.

Ca²⁺+Na₂CO₃→2Na⁺+CaCO₃↓

Mg²⁺+Na₂CO₃→2Na⁺+MgCO₃↓ [Reaction Scheme 4]

(S12) Separation of Calcium Carbonate

The calcium carbonate precipitated in step S11 was separated by solid-liquid separation in a vacuum using a vacuum pump.

The remaining mixed solution was analyzed to have Na (82.25 g/kg), Mg (8.62 g/kg), Ca (0.09 g/kg), and K (2.62 g/kg). Although a small amount of magnesium was lost, most calcium was removed, which guaranteed the production of highly pure HMC.

Subsequently, the same procedures as in steps S20˜S70 of Example 1 were carried out to produce highly pure hydrated magnesium carbonate and magnesium oxide.

The present invention has excellent effects as follows.

First, designed to produce high-purity hydrated magnesium carbonate from a solution where calcium ions and magnesium ions coexist, the present invention can add high value to the resources.

Further, because heavy and light hydrated magnesium carbonate with high purity can be produced together from a solution where calcium ions and magnesium ions coexist, high added-value resources can be created.

Compared to conventional techniques, the method of the present invention can be conducted in a simpler procedure and allows for the production of highly pure magnesium oxide (MgO), thus bringing about an economical benefit.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for manufacturing hydrated magnesium carbonate, comprising:
preparing a material solution containing calcium and magnesium, and a carbonate solution;
mixing the material solution with the carbonate solution calcium while stirring to produce a first mixed solution, with concomitant precipitation of magnesium carbonate; and
mixing a hydroxide solution to the first mixed solution while stirring to give a produce a second mixed solution, with concomitant precipitation of hydrated magnesium carbonate (HMC).

2. The method of claim 1, wherein the carbonate solution is used in such an amount that the magnesium of the material solution is mixed at a molar ratio of 1:0.6˜1:1.0 with carbonate ions.

3. The method of claim 2, wherein the carbonate solution is a sodium carbonate (Na₂CO₃) solution.

4. The method of claim 2, wherein the hydroxide solution is used in such an amount that the magnesium of the material solution is mixed at a molar ratio of 1:0.1˜1:0.3 with hydroxide ions.

5. The method of claim 4, wherein the hydroxide solution is a sodium hydroxide (NaOH) solution.

6. The method of claim 2, wherein the second mixed solution is maintained to have a pH of 8 to 10.

7. The method of claim 6, further comprising, after the production of the second mixed solution,
filtering the second mixed solution to separate the precipitate;
washing the precipitate to remove impurities from the precipitate; and
drying the purified precipitate in an oven.

8. The method of claim 7, wherein the hydrated magnesium carbonate (HMC) is selected from the group consisting of 4(MgCO₃).Mg(OH)₂.4H₂O, 4(MgCO₃).Mg(OH)₂.5H₂O, and 4(MgCO₃) .Mg(OH)₂.8H₂O.

9. The method of claim 7, further comprising roasting the dried precipitate at 800 to 1,000° C. to afford highly pure magnesium oxide (MgO).

10. A method for manufacturing hydrated magnesium carbonate, comprising:
preparing a material solution containing calcium and magnesium, and a carbonate solution;
mixing the material solution with the carbonate solution calcium while stirring to precipitate calcium carbonate;
isolating the precipitated calcium carbonate;
mixing the remaining solution with a carbonate solution by stirring to produce a first mixed solution, with concomitant precipitation of magnesium carbonate; and
adding a hydroxide solution to the first mixed solution while stirring to produce a second mixed solution, with concomitant precipitation of hydrated magnesium carbonate (HMC).

11. The method of claim 10, wherein the carbonate solution is used in such an amount that the magnesium of the material solution is mixed at a molar ratio of 1:0.6˜1:1.0 with carbonate ions.

12. The method of claim 11, wherein the carbonate solution is a sodium carbonate (Na₂CO₃) solution.
